(19) United States
(12) Patent Application Publication
(10) Pub. No.: US 2008/0257876 A1
(43) Pub. Date: Oct. 23, 2008

(54) Defogging Device

(76) Inventor: Victor J. Dubois, St. Agathe (CA)

Correspondence Address: ADE & COMPANY INC., 2157 Henderson Highway, WINNIPEG, MB, R2G1P9, CA

(21) Appl. No.: 11/874,308

(22) Filed: Oct. 18, 2007

Related U.S. Application Data
(60) Provisional application No. 60/862,084, filed on Oct. 19, 2006.

(51) Int. Cl. H05B 1/00

(52) U.S. Cl. 219/200

(57) ABSTRACT

A mirror defogging device comprises a housing and a heating element and fan supported within the housing. The fan directs a flow of air across the heating element and out of the housing through a nozzle. Electrical prongs arranged to be received in an electrical wall socket are arranged to support the housing on a wall locating the socket therein. The nozzle is adjustable both in angular orientation in relation to the housing and in distance relative to the housing to direct the flow of heated air onto a surface of a mirror for defogging the mirror.

This application claims priority to U.S. provisional application No. 60/862,084, filed Oct. 19, 2006.

### FIELD OF THE INVENTION

The present invention relates to a defogging device for directing a flow of heated air at a target object, for example a mirror, for removing fog from the target object.

### BACKGROUND

Bathroom mirrors and other glass like surfaces which are exposed to steam from showers and the like for example commonly collect condensation or fog thereon. Various prior attempts have been made to defog mirrors as described in the following prior art documents: U.S. Pat. No. 4,882,467 belonging to Dimick, U.S. Pat. No. 5,467,423 belonging to Jakubowski, U.S. Pat. No. 5,302,809 belonging to Ghiassy, U.S. Pat. No. 4,037,079 belonging to Armbruster, U.S. Pat. No. 6,653,606 belonging to Son et al., and U.S. Pat. No. 5,731,569 belonging to Crescenzo.

Some attempts include providing heating elements in direct proximity to the mirror to heat the mirror and thus prevent the formation of condensation or fog thereon, however such systems typically involve a complex installation in order to be effective, and may pose certain electrical or fire hazards to users.

Other attempts to defog the mirrors include devices which incorporate some form of heating element and a fan to direct air heated by the element across the surface of the mirror. Known designs however typically require a permanent installation on a proximate supporting surface so as to cause damage to the surface. Known designs are also typically large and cumbersome and do not fit adjacent typical bathroom mirrors. Known designs are also typically limited to a single dedicated use of directing air at the mirror.

### SUMMARY OF THE INVENTION

According to one aspect of the invention there is provided a defogging device for use with an electrical wall socket in a supporting surface for defogging a mirror, the device comprising:

a housing;

a heating element supported within the housing;

a fan supported within the housing;

the fan being arranged to direct a flow of air across the heating element;

electrical prongs arranged to be received in the electrical wall socket so as to provide electrical power to the heating element and to the fan;

a nozzle supported on the housing;

the nozzle being arranged to redirect the flow of air across the heating element to exit the housing therethrough in a flow direction of the nozzle;

the housing being arranged to be substantially supported on the supporting surface by engagement of the electrical prongs with the electrical wall socket.

Use of electrical prongs which are fixed on the housing enable the device to be easily installed simply by insertion into a conventional electrical wall socket without damaging any supporting surfaces in proximity to the bathroom mirror.

The electrical prongs are preferably supported directly on the housing in fixed relation to the housing, the housing being arranged to be wholly supported on the supporting surface by the electrical prongs when the electrical prongs are received in the electrical wall socket.

There may be provided adhesive on the housing arranged to additionally support the housing on the supporting surface.

The nozzle is preferably adjustable in angular orientation relative to the housing to adjust angular orientation of the flow direction relative to the housing.

The nozzle may also be adjustable in distance relative to the housing along the flow direction.

The nozzle is preferably adjustably coupled to the housing by a flexible sleeve arranged to direct the flow of air therethrough as the nozzle is displaced relative to the housing.

The sleeve is preferably arranged to be self-supporting so as to be arranged to support the nozzle relative to the housing at a selected relative orientation between the nozzle and the housing.

When the housing is generally tubular about an upright axis and includes an outlet opening at a top end in communication with the nozzle, the air inlet ports opposite the outlet opening in relation to the fan are preferably located generally circumferentially about the upright axis.

The sleeve may comprise a plurality of annular sections connected in series with one another in which each section is foldable relative to adjacent sections to vary relative angular orientation therebetween.

The nozzle is preferably pivotal relative to the housing through a range of at least 90 degrees by folding the annular sections relative to one another.

The nozzle may be pivotal relative to the housing from a first position in which the flow direction of the nozzle is generally parallel to an axis of rotation of the fan and a second position in which the flow direction of the nozzle is generally perpendicular to the axis of rotation of the fan.

A mouth opening of the nozzle may be wider than a diameter of the outlet opening in a first direction and narrower than the diameter of the outlet opening in a second direction perpendicular to the first direction.

When the housing includes a rear face from which the electrical prongs project perpendicularly, the nozzle preferably has a mouth opening which is elongate so as to be longer in a lateral direction oriented parallel to the rear face of the housing.

The nozzle preferably diverges in the lateral direction towards the mouth opening.

There may be provided a ball joint coupling the nozzle for pivotal movement relative to the housing about a laterally extending axis lying parallel to a plane of a rear side of the housing from which the electrical prongs project perpendicularly in which the ball joint is arranged to communicate a flow of air therethrough from the fan to the nozzle.

When the housing extends along an upright axis between a bottom end and an open top end in communication with the nozzle, the nozzle is preferably pivotal about a nozzle axis lying generally perpendicular to the upright axis. A sleeve of fixed orientation inclined upwardly and forward in relation to the open top end of the housing, outwardly and away from the rear face of the housing, preferably supports the ball joint at an outer end thereof so that the nozzle supported by the ball joint is spaced upwardly and forwardly in relation to the housing.

According to a second aspect of the present invention there is provided a defogging device for defogging a mirror, the device comprising:

a housing arranged to be supported on an upright supporting surface;

a heating element supported within the housing;

a fan supported within the housing;

the fan being arranged to direct a flow of air across the heating element;

electrical prongs arranged to be received in an electrical wall socket so as to provide electrical power to the fan and the heating element;

a nozzle supported on the housing; the nozzle being arranged to redirect the flow of air across the heating element to exit the housing therethrough in a flow direction of the nozzle;

the nozzle being adjustable in orientation in relation to the housing to adjust orientation of the flow direction.

According to a third aspect of the present invention there is provided a defogging device for defogging a mirror, the device comprising:

a housing arranged to be supported on an upright supporting surface;

a heating element supported within the housing;

a fan supported within the housing;

the fan being arranged to direct a flow of air across the heating element;

electrical prongs arranged to be received in an electrical wall socket so as to provide electrical power to the fan and the heating element;

a nozzle supported on the housing;

the nozzle being arranged to redirect the flow of air across the heating element to exit the housing therethrough in a flow direction of the nozzle;

the nozzle being adjustable in relation to the housing along the flow direction.

By providing a nozzle which is either adjustable in orientation or which can be extended or retracted in relation to the housing, the flow of heated air can be used for other purposes in addition to defogging mirrors.

One embodiment of the invention will now be described in conjunction with the accompanying drawings in which:

### BRIEF DESCRIPTION OF THE DRAWINGS

FIG. 1 is a perspective view of the defogging device.

FIG. 2 is a partly sectional front elevational view of the device.

FIG. 3 is a side elevational view of the device with the nozzle in a retracted position.

FIG. 4 is a side elevational view of the nozzle in an extended and pivoted orientation in relation to FIG. 3.

FIG. 5 is a side elevational view of the nozzle pivoted into a different orientation in relation to FIGS. 3 and 4.

FIG. 6 is a sectional front elevational view of the device.

FIG. 7 is a perspective view of a second embodiment of the defogging device.

FIG. 8 and FIG. 9 are respective side elevational and front elevational views of the defogging device according to FIG. 7 with the sleeve in a collapsed position.

FIG. 10 and FIG. 11 are respective side elevational and front elevational views of the nozzle extended and angularly offset in relation to the housing according to the second embodiment of the device.

FIG. 12 is a side elevational view of a third embodiment of the defogging device.

FIG. 13 is a front elevational view of the device of FIG. 12.

FIG. 14 is a sectional view of the nozzle according to the third embodiment.

In the drawings like characters of reference indicate corresponding parts in the different figures.

### DETAILED DESCRIPTION

Referring to the accompanying figures there is illustrated a defogging device generally indicated by reference numeral 10. The device 10 is particularly suited for removing or reducing fog and condensation on target objects and in the surrounding target area of objects including for example bathroom mirrors or other related glass like surfaces.

Though various embodiments are illustrated in the accompanying figures, the common features will first be described herein.

The device 10 includes a housing 12 comprising a hollow plastic enclosure having an outlet opening 14 which spans the top end thereof. The housing 12 extends downwardly and tapers inwardly from the outlet opening 14 at the top end to a narrower bottom end 16. A plurality of inlet ports 18 are provided in the walls of the housing 12 adjacent the bottom end at spaced positions in a circumferential direction about an upright axis of the housing 12 between top and bottom ends thereof. The inlet ports 18 are provided in a front side of the housing 12 opposite a flat rear side 20 which is suitably arranged for abutment flat against an upright supporting surface when mounted at a conventional electrical wall socket 22.

The housing 12 includes a set of electrical prongs 24 projecting from the rear side 20 in fixed relative orientation for mating connection with the wall socket 22. The prongs 24 are suitably spaced and dimensioned to fit within the wall socket 22 with sufficiently close tolerance so that the friction between the electrical prongs 24 and the electrical wall socket 22 is sufficient to hold the housing 12 in an upright orientation against the supporting wall within which the wall socket 22 is located.

An electric motor 26 is mounted within the interior of the housing for driving rotation of a fan 28 also supported within the housing. The motor 26 is mounted adjacent the bottom end of the housing and is connected to the electrical prongs 24 in a suitable manner for delivering electrical power to the motor. The fan 28 is positioned directly above the motor 26 and is oriented to direct a flow of air in through the inlet ports 18 adjacent the bottom end of the housing below the fan, upwardly through the outlet opening 14 at the top end of the housing. Accordingly, the inlet ports and the open top end of the housing communicate with opposing sides of the fan.

The heating element 30 is mounted between the fan 28 and the outlet opening 14 for heating the flow of air generated by the fan 28 to blow across the heating element as it moves towards the outlet opening. The heating element 30 is an electrical resistance heating element which also receives electrical power by connecting to the electrical prongs 24 in a suitable manner.

A nozzle 32 is adjustably supported on the outlet opening 14 of the housing for redirecting the flow generated by the fan 28 within the housing to exit the housing in the flow direction of the nozzle 32. The nozzle is supported on the housing by an adjustable sleeve 34.

A power switch 42 is provided adjacent the bottom end of the housing at the exterior side to manually connect and disconnect the fan motor 26 and heating element 30 to and from the electrical prongs 24 as desired by the user to turn on and turn off the device.

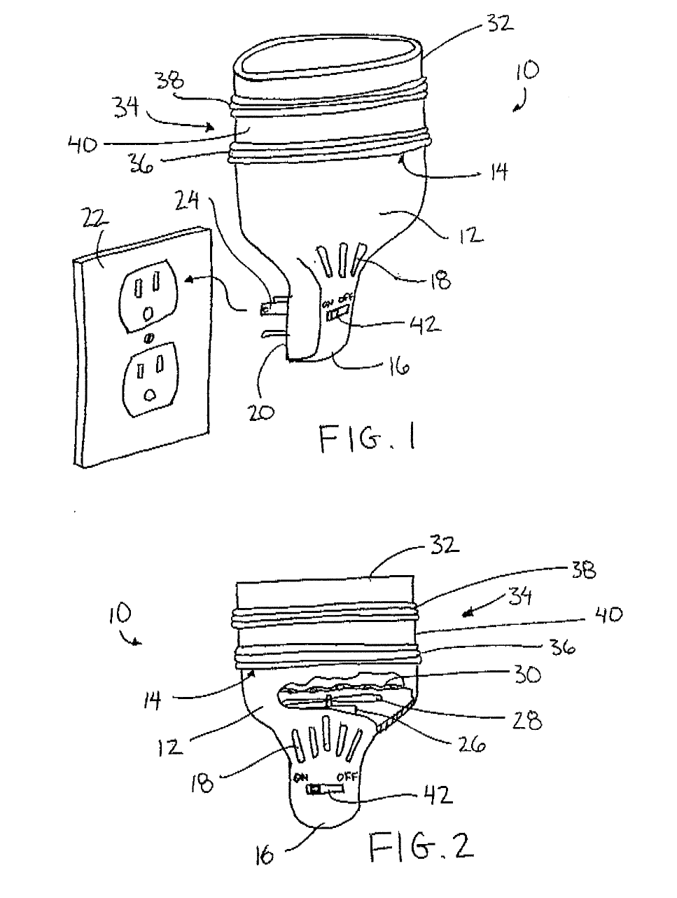

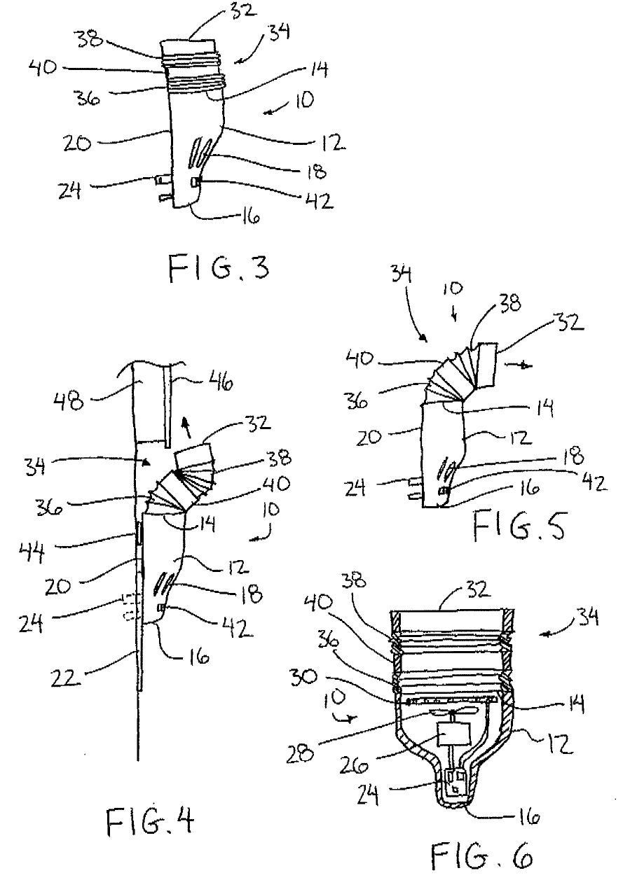

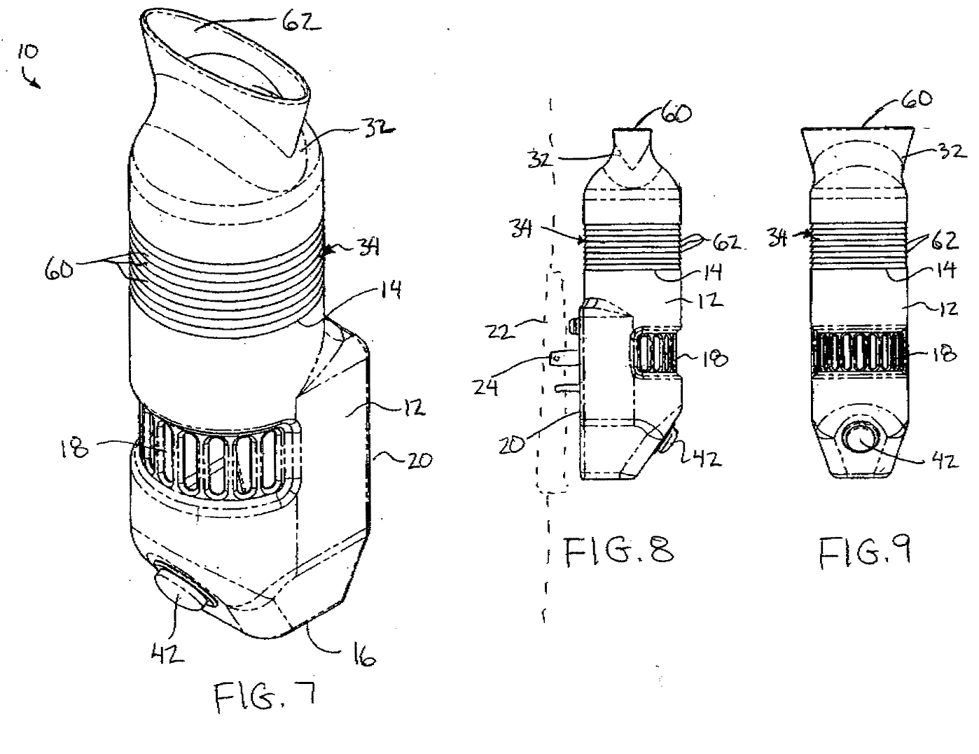

Turning now more particularly to the first embodiment of FIGS. 1 through 6, the sleeve 34 in this instance generally comprises a first flexible joint 36 coupled to the outlet opening 14 on the housing, a second flexible joint 38 connected directly to the nozzle 32, and a rigid collar 40 which is connected between the first and second flexible joints for communicating therebetween. The first and second flexible joints and the rigid collar 40 connected therebetween form sequential portions of the sleeve 34 communicating the flow of air from the outlet opening through the nozzle 32.

Each of the flexible joints 36 and 38 comprises flexible material arranged in an accordion like structure in which a plurality of annular sections can be folded relative to one another. The material at the folds of the flexible joints have sufficient stiffness to retain their shape once the flexible joints have been reoriented manually by a user into a different position. The annular sections of the flexible joints 36 and 38 can be collapsed and extended relative to one another in an axial flow direction of the respective nozzle or outlet opening of the housing connected thereto. The annular sections can also be reoriented relative to one another so that the flexible joints form curved or bending sections of the sleeve 34 to reorient the flow direction of the nozzle relative to the housing.

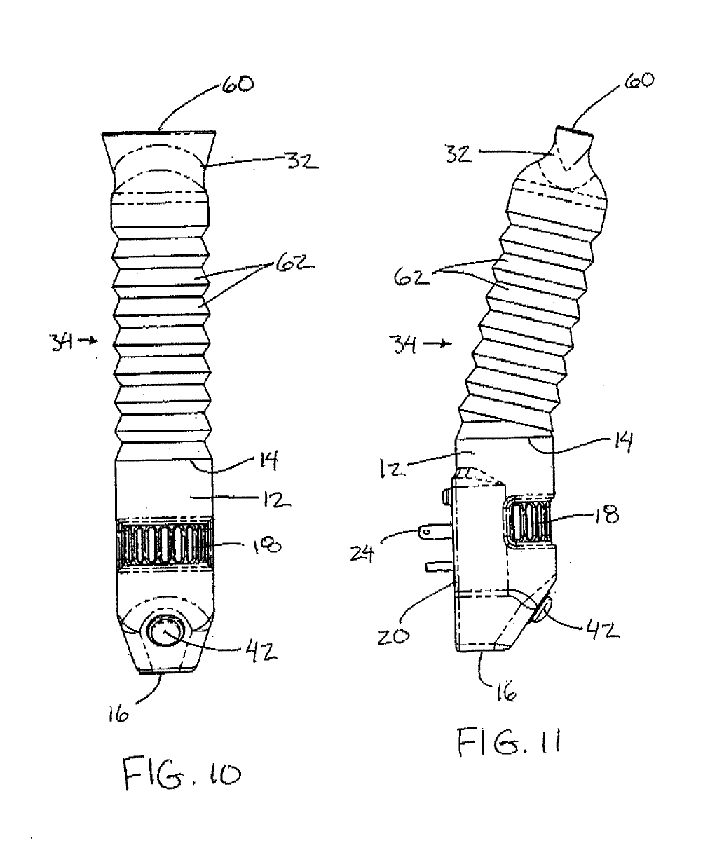

Turning now to FIG. 7 through 11 a second embodiment of the device 10 is illustrated in which the nozzle 32 is again coupled to the outlet opening 14 of the housing by a sleeve 34, however the sleeve 34 in this instance comprises a continuous accordion like sleeve of circular cross section between the nozzle 32 and the outlet openings. The sleeve 34, similar to the joints of the previous embodiment, comprises a plurality of annular sections 62 which are foldable relative to one another to define eight separate sections of the sleeve in series with one another. Each annular section is foldable relative to adjacent sections to vary the relative angular orientation therebetween in any direction. Accordingly by folding some sections relative to one another in a first direction and folding other sections relative to one another in an opposing direction, the sleeve can be configured to follow a generally S-shaped pattern. Each section is pivotal relative to adjacent sections through a range of approximately 15° so that when all eight sections are pivoted in the same direction or are folded to be angularly offset relative to one another in the same direction, the nozzle is effectively pivoted relative to the housing through a range of 120°.

In the second embodiment, the housing is generally elongate and tubular about a longitudinal axis extending between top and bottom ends of the housing. The tubular shape of the housing and the sleeve 34 are similar in diameter to one another. In this instance movement of the nozzle relative to the housing is such that the nozzle can be displaced from a first position in which the flow direction of the nozzle is co-axial and parallel with the longitudinal axis of the housing, to an intermediate position in which the flow direction of the nozzle extends generally radially outwardly from the axis of the housing so that the flow direction is perpendicular to the housing, and then to a final position in which the flow direction of the nozzle has been pivoted through 1200 relative to the upright axis of the housing so that that nozzle is directed downwardly and outwardly in relation to the open top end of the housing.

Each of the annular sections of the sleeve can also be folded upon itself to be collapsed such that the sleeve 34 is adjustable in length along the direction of flow through the nozzle and along the longitudinal axis of the housing. Adjusting the length of the sleeve 34 effectively permits the nozzle to be adjusted in distance or spacing relative to the housing in the flow direction of the nozzle with or without angular deflection of the nozzle relative to the longitudinal axis of the housing.

When the housing is tubular about an upright axis, the inlet ports 18 are located in a circumferential pattern about the upright axis spaced apart from one another. The fan is rotatable about the longitudinal axis of the housing such that the ports 18 are circumferentially about a periphery of the fan sweep area.

Also in the second embodiment, the nozzle includes a mouth opening 60 which is elongate in a first direction in a plane of the opening so that the nozzle is wider than a diameter of the outlet opening of the housing and the sleeve in the first direction, while being narrower than the diameter of the outlet opening and the sleeve in a second direction perpendicular to the first direction in the plane of the opening. The nozzle 32 is shaped so as to diverge in the elongate first direction towards the mouth opening 60. When the rear face of the housing, from which the electrical prongs project perpendicularly therefrom, is vertically oriented and parallel to the upright axis of the housing, the first direction in which the nozzle is elongate is oriented to extend laterally and parallel to a plane of the rear face of the housing. Accordingly when the device is inserted into a wall socket below a mirror, the nozzle extends upwardly towards the mirror in a widening fan pattern, elongate in a lateral direction across the mirror, to spread the heated air from the device across the face of the mirror.

When mounting on an upright supporting surface, an adhesive strip 44 may also be provided at the flat rear side of the housing adjacent the top end for adhering the housing to an upright supporting wall within which an electrical wall socket is located to provide some additional support to maintain the housing supported on the upright wall in addition to frictional engagement of the electrical prongs within the wall socket 22.

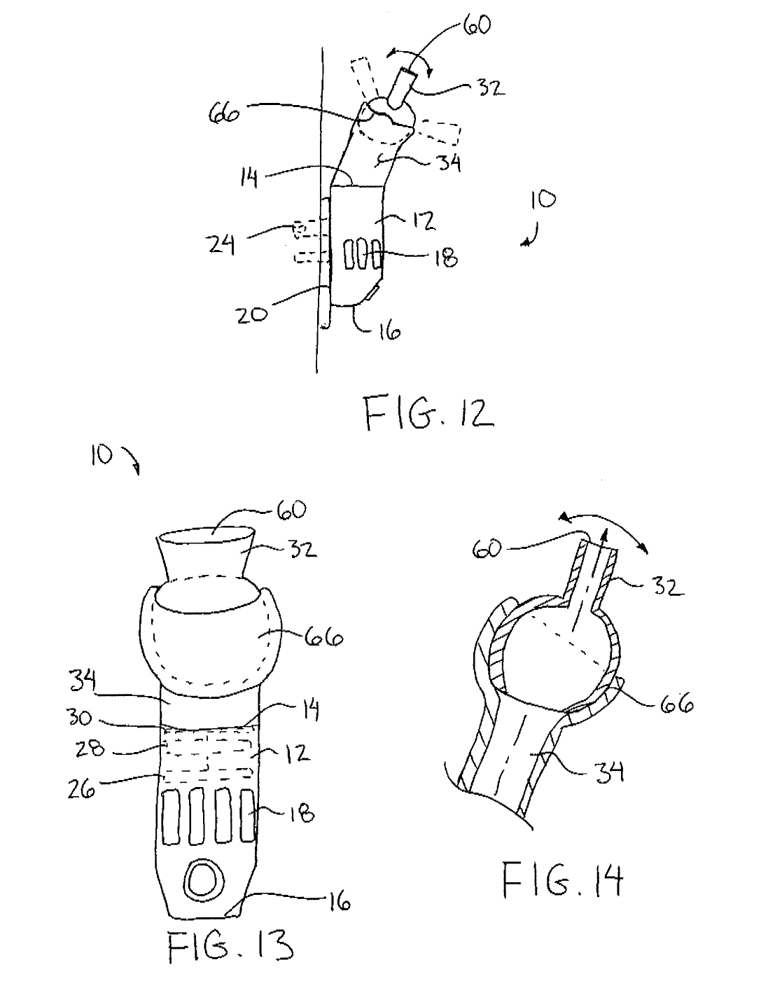

Turning now more particularly to the embodiments of FIGS. 12 through 14, the nozzle 32 in this instance is similarly configured to the nozzle of the previous embodiment so as to diverge towards the mouth opening 60 which is elongate in a lateral direction. The nozzle 32 in the embodiment of FIGS. 12 through 14 is also arranged to pivot about a nozzle axis which is generally horizontal and extends in a lateral direction parallel to the plane of the rear face from which the electrical prongs 24 project perpendicularly. The nozzle is pivotal through a range in the order of 120° from a generally upward or vertical orientation to a downward and forward position a shown in broken line in FIG. 12.

Again similarly to the previous embodiment, the nozzle is supported on the housing by a sleeve 34, however the differs in that the sleeve 34 is fixed in orientation relative to the housing and the nozzle 32 is supported at an outer free end of the sleeve by a ball joint 66. The ball joint 66 supports the nozzle for pivotal movement about the nozzle axis which extends horizontally and perpendicularly to the upright longitudinal axis of the housing about which the fan rotates. The nozzle is thus pivotal relative to the sleeve 34 which is fixed in orientation relative to the housing 12. The ball joint is arranged to have a passage therethrough which is near in diameter to the diameter of the sleeve and housing to permit a flow of air to be communicated therethrough from the fan to the nozzle 32.

The sleeve 34 according to the third embodiment extends upwardly and forwardly from the open top end of the housing at an incline outward and away from the rear face of the housing from which the electrical prongs project to support the ball joint and the nozzle thereon at the outer top end of the sleeve. A longitudinal axis of the sleeve 34 is preferably offset from a vertical axis of the housing by approximately 22.5°.

The ball joint 66 is formed by a socket integrally formed at the outer end of the sleeve 34 which receives a ball rotatably therein to which the nozzle is fixed for rotation therewith relative to the socket on the sleeve.

In use, the device is easily mounted in place by inserting the prongs into a wall socket 22 in proximity to a bathroom mirror. The length of the sleeve 34 and its orientation can be adjusted as desired by the user to adjust the location and orientation of the nozzle 32 as desired. Even when the mirror 46 to be defogged is located on a cabinet 48 which projects outwardly from the wall locating the socket 22 therein as shown in FIG. 4, the two flexible joints 36 and 38 in the sleeve 34 supporting the nozzle on the housing enable the nozzle to be offset from the wall sufficiently to overcome the thickness of the cabinet 48 so that the nozzle may still be directed at the surface of the mirror 46 to direct the heated flow of air from the fan 28 through the nozzle and across the surface of the target object. The two flexible joints 36 and 38 in the sleeve 34 also allow the nozzle to be redirected outwardly, substantially perpendicularly to a plane of the rear side as shown in FIG. 5. In this position, the device is well suited for drying the hands or face of a user.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A defogging device for use with an electrical wall socket in a supporting surface for defogging a mirror, the device comprising:
a housing;
a heating element supported within the housing;
a fan supported within the housing;
the fan being arranged to direct a flow of air across the heating element;
electrical prongs arranged to be received in the electrical wall socket so as to provide electrical power to the heating element and to the fan;
a nozzle supported on the housing;
the nozzle being arranged to redirect the flow of air across the heating element to exit the housing therethrough in a flow direction of the nozzle;
the housing being arranged to be substantially supported on the supporting surface by engagement of the electrical prongs with the electrical wall socket.

2. The device according to claim 1 wherein the electrical prongs are supported directly on the housing in fixed relation to the housing, the housing being arranged to be wholly supported on the supporting surface by the electrical prongs when the electrical prongs are received in the electrical wall socket.

3. The device according to claim 1 wherein there is provided adhesive on the housing arranged to additionally support the housing on the supporting surface.

4. The device according to claim 1 wherein the nozzle is adjustable in angular orientation relative to the housing to adjust angular orientation of the flow direction relative to the housing.

5. The device according to claim 1 wherein the nozzle is adjustable in distance relative to the housing along the flow direction.

6. The device according to claim 1 wherein the nozzle is adjustably coupled to the housing by a flexible sleeve arranged to direct the flow of air therethrough as the nozzle is displaced relative to the housing.

7. The device according to claim 6 wherein the sleeve is arranged to be self-supporting so as to be arranged to support the nozzle relative to the housing at a selected relative orientation between the nozzle and the housing.

8. The device according to claim 1 wherein the housing is generally tubular about an upright axis and includes an outlet opening at a top end in communication with the nozzle and at least one air inlet port opposite the outlet opening in relation to the fan, said at least one air inlet port being located generally circumferentially about the upright axis.

9. The device according to claim 1 wherein the sleeve comprises a plurality of annular sections connected in series with one another, each section being foldable relative to adjacent sections to vary relative angular orientation therebetween.

10. The device according to claim 9 wherein the nozzle is pivotal relative to the housing through a range of at least 90 degrees by folding the annular sections relative to one another.

11. The device according to claim 10 wherein the nozzle is pivotal relative to the housing from a first position in which the flow direction of the nozzle is generally parallel to an axis of rotation of the fan and a second position in which the flow direction of the nozzle is generally perpendicular to the axis of rotation of the fan.

12. The device according to claim 1 wherein a mouth opening of the nozzle is wider than a diameter of the outlet opening in a first direction and the mouth of the nozzle is narrower than the diameter of the outlet opening in a second direction perpendicular to the first direction.

13. The device according to claim 1 wherein the housing includes a rear face from which the electrical prongs project perpendicularly thereto and the nozzle has a mouth opening which is elongate so as to be longer in a lateral direction oriented parallel to the rear face of the housing.

14. The device according to claim 13 wherein the nozzle diverges in the lateral direction towards the mouth opening.

15. The device according to claim 1 wherein there is provided a ball joint coupling the nozzle for pivotal movement relative to the housing about a laterally extending axis lying parallel to a plane of a rear side of the housing from which the electrical prongs project perpendicularly, the ball joint being arranged to communicate a flow of air therethrough from the fan to the nozzle.

16. The device according to claim 15 wherein the housing extends along an upright axis between a bottom end and an open top end in communication with the nozzle, the nozzle being pivotal about a nozzle axis lying generally perpendicular to the upright axis.

17. A defogging device for defogging a mirror, the device comprising:
a housing arranged to be supported on an upright supporting surface;
a heating element supported within the housing;
a fan supported within the housing;
the fan being arranged to direct a flow of air across the heating element;
electrical prongs arranged to be received in an electrical wall socket so as to provide electrical power to the fan and the heating element;
a nozzle supported on the housing;
the nozzle being arranged to redirect the flow of air across the heating element to exit the housing therethrough in a flow direction of the nozzle;
the nozzle being adjustable in orientation in relation to the housing to adjust orientation of the flow direction.

18. The device according to claim 17 wherein the nozzle is adjustable in relation to the housing along the flow direction.

19. A defogging device for defogging a mirror, the device comprising:
a housing arranged to be supported on an upright supporting surface;
a heating element supported within the housing;
a fan supported within the housing;
the fan being arranged to direct a flow of air across the heating element;
electrical prongs arranged to be received in an electrical wall socket so as to provide electrical power to the fan and the heating element;
a nozzle supported on the housing;
the nozzle being arranged to redirect the flow of air across the heating element to exit the housing therethrough in a flow direction of the nozzle;
the nozzle being adjustable in relation to the housing along the flow direction.
